(19) United States
(12) Patent Application Publication
(10) Pub. No.: US 2023/0189848 A1
(43) Pub. Date: Jun. 22, 2023

(54) COMPOSITIONS AND METHODS FOR INCREASING LACTATION

(71) Applicant: Maureen Quinlan, Costa Mesa, CA (US)

(72) Inventor: Maureen Quinlan, Costa Mesa, CA (US)

(21) Appl. No.: 17/925,801

(22) PCT Filed: May 18, 2021
(86) PCT No.: PCT/US2021/032973

§ 371 Date: Nov. 16, 2022

Related U.S. Application Data
(60) Provisional application No. 63/026,633, filed on May 18, 2020.

(51) Int. Cl. A23L 2/60; A23L 2/06; A23L 33/00

(52) U.S. Cl. CPC A23L 2/60; A23L 2/06; A23L 33/30

(57) ABSTRACT

Disclosed herein are beverages for increasing lactation in nursing mothers. Also disclosed herein are methods of preparing such beverages.

### RELATED APPLICATION(S)

This application claims the benefit of U.S. Provisional Application No. 63/026,633, filed on May 18, 2020, the entire teachings of which are incorporated herein by reference in its entirety.

### BACKGROUND OF THE INVENTION

Breastfeeding is the best source of nutrition for most infants. It can reduce the risk for certain short- and long-term health conditions for both infants and their mothers. However, only 1 in 4 infants are exclusively breastfed by the time they reach 6 months of age. Although most mothers want to breastfeed for an extended period of time, at least 60% of mothers do not breastfeed for as long as they originally intended. There are numerous reasons why a mother may stop breastfeeding earlier than intended including issues with lactation and latching, concerns regarding infant nutrition and weight gain, concerns regarding consumption of required medication(s), unsupportive work policies and lack of parental leave, cultural norms and lack of family support, unsupportive hospital practices and policies, etc.

The medical costs for mothers and infants in the United States as a result of low rates of breastfeeding are estimated to be at least $3 billion/year, and in some estimates, are as a much as $13 billion/year. Infants who breastfeed have reduced risk of asthma, obesity, type 1 diabetes, severe lower respiratory diseases, acute ear infections, sudden infant death syndrome, gastrointestinal infections, and necrotizing enterocolitis (NEC) for preterm infants. There are additionally benefits for the mother to continue breastfeeding including a reduced risk of high blood pressure, type 2 diabetes, ovarian cancer, and breast cancer.

The breastfeeding-enhancement industry has grown over the past several years from tinctures and dry bagged teas to capsules, cookies and bars but currently there are not convenient ready-to-drink beverages pleasing to the palate, and therefore more likely to be consumed consistently. Cookies and capsules that are currently available on the market are an attempt to provide convenient breastfeeding enhancements to nursing mothers, but fails to address a nursing mothers hydration needs. Cookies, such as MilkMakers, can be caloric and require several servings per day. Pills, such as Legendairy Milk, are low in calories but limit daily consumption which restricts a mother's control over her production. Bagged teas, such as Earth Mama Angel Baby, address a portion of the hydration component, but taste medicinal and are not convenient considering the time required to boil water, steep the tea bags, then cool to a drinkable temperature. There continues to be a need for healthy, ready-to-consume products that will assist mothers with continuing to nurse for an extended period of time.

### SUMMARY OF THE INVENTION

The invention described herein relates to human lactation and breast feeding and a ready-to-drink lactation tea that will increase and maintain breastmilk production and support the hydration needs of nursing mothers. Lactation is defined as the secretion of milk from the mammary glands and the period of time that a mother lactates to feed her young. Specifically, it relates to the increase and or maintenance of a mother's milk secretion using a blend of ingredients known in lactation as a galactagogue. Galactagogues are defined as a substance or substances (food, herbs or medications) that promote lactation in humans, and may be used to treat low milk supply. The invention described in this patent application includes a proprietary blend of lactation supporting herbs (galactagogues) which are custom blended with sweeteners and other natural flavorings to allow a nursing mother the flexibility to consume an enjoyable, ready to drink lactation beverage as conveniently and consistently as she would any other beverage.

Disclosed herein are beverage compositions comprising an herbal blend of fennel, anise, coriander, lemon grass, lemon verbena, marshmallow root, blessed thistle, optionally fenugreek, and optionally spearmint; and a sweetener. In some embodiments, the beverage composition does not comprise fenugreek and/or spearmint. The beverage composition may be a ready-to-drink beverage composition, e.g., a ready-to-drink tea beverage composition. In some aspects, the ready-to-drink tea beverage is a ready-to-drink lactation tea beverage.

In some embodiment, the herbal blend comprises about 39-41 wt % fennel seed, about 31-33 wt % anise seed, about 11-13 wt % coriander seed, about 2-4 wt % blessed thistle leaves, about 3-5 wt % marshmallow root, about 2-4 wt % lemongrass leaves, and about 2-4 wt % lemon verbena leaves. In one embodiment, the herbal blend comprises about 40 wt % fennel seed, about 32 wt % anise seed, about 12 wt % coriander seed, about 4 wt % blessed thistle leaves, about 5 wt % marshmallow root, about 4 wt % lemongrass leaves, and about 3 wt % lemon verbena leaves. In some embodiments, the herbal blend comprises about 34-36 wt % fennel seed, about 27-29 wt % anise seed, about 9-11 wt % coriander seed, about 2-4 wt % blessed thistle leaves, about 10-12 wt % fenugreek seed, about 3-5 wt % marshmallow root, about 2-4 wt % lemongrass leaves, and about 1-3 wt % lemon verbena leaves. In one embodiment, the herbal blend comprises about 35 wt % fennel seed, about 29 wt % anise seed, about 11 wt % coriander seed, about 3 wt % blessed thistle leaves, about 12 wt % fenugreek seed, about 4 wt % marshmallow root, about 3 wt % lemongrass leaves, about 3 wt % lemon verbena leaves. In some embodiments, the herbal blend comprises about 37-39 wt % fennel seed, about 30-32 wt % anise seed, about 10-12 wt % coriander seed, about 2-4 wt % blessed thistle leaves, about 3-5 wt % marshmallow root, about 2-4 wt % lemongrass leaves, about 2-4 wt % lemon verbena leaves, and about 2-4 wt % spearmint leaves. In one embodiment, the herbal blend comprises about 39 wt % fennel seed, about 31 wt % anise seed, about 12 wt % coriander seed, about 3 wt % blessed thistle leaves, about 5 wt % marshmallow root, about 4 wt % lemongrass leaves, about 3 wt % lemon verbena leaves, and about 4 wt % spearmint leaves.

In some embodiments, the sweetener is selected from the group consisting of monk fruit, maple syrup, honey, sugar, stevia, and combinations thereof. In one embodiment, the sweetener is a combination of monk fruit and maple syrup. The beverage may further comprise additional ingredients including lemon juice, hibiscus, spearmint leaves, alfalfa chlorophyll, a spice blend, and/or milk. In one embodiment, the beverage composition further includes lemon juice, hibiscus, and/or spearmint leaves. In one embodiment, the beverage composition further includes lemon juice and/or alfalfa chlorophyll. In one embodiment, the beverage comprises a spice blend (e.g., a blend of one or more of cinnamon, ginger, cardamom, black pepper, nutmeg, and cloves) and/or milk (e.g., oat milk, cows milk, goat milk, soy milk, almond milk, coconut milk, hemp milk, or cashew milk).

In some embodiments, consumption of the beverage composition by a nursing mother results is increased lactation. For example, consumption by a nursing mother of about 24 oz of the beverage per day for a period of three days may result in increased lactation of greater than 25%, or may results in increased lactation of about 50% to 100%.

In some embodiments, the beverage composition is prepared using a hot or cold brew production process.

Also disclosed herein are methods increasing lactation in a nursing mother. The methods comprise the nursing mother consuming the beverage composition, e.g., the ready-to-drink tea beverage, described herein.

In some embodiments, the nursing mother consumes about 24 oz of the beverage per day. In some embodiments, the nursing mother consumes about 24 oz of the beverage per day for at least three days, and in some aspects, for at least 1 week, at least 1 month, at least 3 months, at least 6 months, at least 9 months, or at least 1 year. In some embodiments, consumption of the beverage described herein results in increased lactation, e.g., by about 25% or by about 50%-100%.

### DETAILED DESCRIPTION OF THE INVENTION

This invention described herein relates to human lactation and breast feeding and a lactation beverage (e.g., a ready-to-drink lactation tea) that will increase and maintain breastmilk production and support the hydration needs of nursing mothers. Lactation is defined as the secretion of milk from the mammary glands, and also refers to the period of time that a mother lactates to feed her young. Specifically, the invention relates to the increase and or maintenance of a mother's milk secretion using a blend of ingredients known in lactation as a galactagogue. Galactagogues are substances (e.g., food, herbs or medications) that promote lactation in humans, and may be used to treat low milk supply. They may be natural or synthetic compositions.

Described herein is a beverage composition (e.g., a ready-to-drink beverage) comprising one or more lactation supporting herbs (i.e., galactagogues) which are custom blended with sweeteners and other natural flavoring to allow a nursing mother the flexibility to consume an enjoyable, ready-to-drink lactation beverage as conveniently and consistently as she would any other beverage. In some embodiments, the beverage composition is a ready-to-drink lactation beverage.

In some embodiments, a beverage composition (e.g., a ready-to-drink lactation beverage) is ingested by a lactating woman for the purpose of increasing, maintaining and supporting her breast milk supply. By using a blend of herbs as opposed to a single herb, the likelihood that one or more of the herbs will be effective for boosting lactation increases. Increased lactation may result in dehydration in nursing mothers, but by ingesting the herbs as part of a ready-to-drink beverage, the galactagogues are supported by the increased intake of liquid necessary to reduce risk of dehydration.

In some embodiments, a beverage composition (e.g., ready-to-drink lactation beverage) includes one or more galactagogues. In some aspects, a beverage composition includes one or more lactation-boosting herbs selected from the group comprising shatavari, torbangun, milk thistle, chasteberry, goat's rue, alfalfa, nettle, oatmeal, vervain, red raspberry leaf, moringa, fennel, anise, fenugreek, blessed thistle, marshmallow root, lemongrass, lemon verbena, coriander, caraway, dandelion, and spearmint. In certain embodiments, the beverage composition includes an herbal blend of fennel, anise, coriander, fenugreek, blessed thistle, marshmallow root, lemongrass, lemon verbena and spearmint. In one embodiment, the beverage composition does not include fenugreek seed. In one embodiment, the beverage composition does not include spearmint leaves. In another embodiment, the beverage composition does not include fenugreek seed and spearmint leaves. In some embodiments, an herbal blend of one or more herbs (e.g., lactation boosting herbs) is prepared prior to incorporating the herbs into the beverage. In other embodiments, individual herbs are added to the beverage consecutively.

In some embodiments, an herbal blend comprises 3 to 10, 4 to 9, 5 to 8, or 6 to 7 different herbs. In some embodiments, a beverage (e.g., a ready-to-drink lactation beverage) comprises about 0.5-1.5 wt %, or 0.75-1.25 wt %, or 0.9-1.1 wt % of an herbal blend. In one embodiment, a beverage comprises about 1 wt % of an herbal blend.

In some embodiments, an herbal blend comprises the same amount of each herb contained within the blend. For example, an herbal blend may comprise 5 mg each of six different herbs in an herbal blend. Alternatively, an herbal blend may comprise optimized amounts of each herb contained within the blend. For example, an herbal blend may comprise 1 mg of a first, second, and third herb; 2 mg of a fourth, fifth, and sixth herb; and 3 mg of a seventh, eighth, and ninth herb.

In some embodiments, an herbal blend comprises about 15-50 wt %, 33-41 wt %, or 30-35 wt % fennel seed; about 5-40 wt %, 25-33 wt %, or 20-25 wt % anise seed; about 0.5-30 wt %, 7-15 wt %, or 10-13 wt % coriander seed; about 0.05-15 wt %, 0.5-7 wt %, or 2-5 wt % blessed thistle leaves; about 0-30 wt %, 0-15 wt %, or 7-13 wt % fenugreek seed; about 0.25-25 wt %, 2-10 wt %, or 3-6 wt % marshmallow root; about 0.25-20 wt %, 1-10 wt %, or 2-5 wt % lemongrass leaves; about 0.05-20 wt %, 0.5-10 wt %, or 1-4 wt % lemon verbena leaves; and about 0-20 wt %, 0-7 wt % or 1-4 wt % spearmint leaves. In one embodiment, an herbal blend comprises about 30-41 wt % fennel seed, about 25-33 wt % anise seed, about 9-13 wt % coriander seed, about 2-4 wt % blessed thistle leaves, about 0-12 wt % fenugreek seed, about 3-5 wt % marshmallow root, about 3-4 wt % lemongrass leaves, about 2-4 wt % lemon verbena leaves, and about 0-4 wt % spearmint leaves. In one embodiment, the herbal blend comprises about 33-35 wt % fennel seed, about 26-28 wt % anise seed, about 9-11 wt % coriander seed, about 1-3 wt % blessed thistle leaves, about 10-12 wt % fenugreek seed, about 3-5 wt % marshmallow root, about 2-4 wt % lemongrass leaves, about 1-3 wt % lemon verbena leaves, and about 2-4 wt % spearmint leaves. In one embodiment, where the herbal blend does not comprise fenugreek, the herbal blend comprises about 37-39 wt % fennel seed, about 30-32 wt % anise seed, about 10-12 wt % coriander seed, about 2-4 wt % blessed thistle leaves, about 3-5 wt % marshmallow root, about 2-4 wt % lemongrass leaves, about 2-4 wt % lemon verbena leaves, and about 2-4 wt % spearmint leaves. In one embodiment, where the herbal blend does not comprise spearmint, the herbal blend comprises about 34-36 wt % fennel seed, about 27-29 wt % anise seed, about 9-11 wt % coriander seed, about 2-4 wt % blessed thistle leaves, about 10-12 wt % fenugreek seed, about 3-5 wt % marshmallow root, about 2-4 wt % lemongrass leaves, and about 1-3 wt % lemon verbena leaves. In one embodiment, where the herbal blend does not comprise fenugreek or spearmint, the herbal blend comprises about 39-41 wt % fennel seed, about 31-33 wt % anise seed, about 11-13 wt % coriander seed, about 2-4 wt % blessed thistle leaves, about 3-5 wt % marshmallow root, about 2-4 wt % lemongrass leaves, and about 2-4 wt % lemon verbena leaves.

In one embodiment, an herbal blend comprises about 34 wt % fennel seed, 24 wt % anise seed, 10 wt % coriander seed, 3 wt % blessed thistle leaves, 11 wt % fenugreek seed, 6 wt % marshmallow root, 3 wt % lemongrass leaves, 3 wt % lemon verbena leaves, and 6 wt % spearmint leaves. In another embodiment, an herbal blend comprises about 34 wt % fennel seed, about 28 wt % anise seed, about 10 wt % coriander seed, about 3 wt % blessed thistle leaves, about 11 wt % fenugreek seed, about 4 wt % marshmallow root, about 3 wt % lemongrass leaves, about 3% lemon verbena leaves, and about 3 wt % spearmint leaves. In one embodiment, where the herbal blend does not comprise fenugreek, the herbal blend comprises about 39 wt % fennel seed, about 31 wt % anise seed, about 12 wt % coriander seed, about 3 wt % blessed thistle leaves, about 5 wt % marshmallow root, about 4 wt % lemongrass leaves, about 3 wt % lemon verbena leaves, and about 4 wt % spearmint leaves. In one embodiment, where the herbal blend does not comprise spearmint, the herbal blend comprises about 35 wt % fennel seed, about 29 wt % anise seed, about 11 wt % coriander seed, about 3 wt % blessed thistle leaves, about 12 wt % fenugreek seed, about 4 wt % marshmallow root, about 3 wt % lemongrass leaves, about 3 wt % lemon verbena leaves. In one embodiment, where the herbal blend does not comprise fenugreek or spearmint, the herbal blend comprises about 40 wt % fennel seed, about 32 wt % anise seed, about 12 wt % coriander seed, about 4 wt % blessed thistle leaves, about 5 wt % marshmallow root, about 4 wt % lemongrass leaves, and about 3 wt % lemon verbena leaves.

The various herbs selected to comprise the herbal blend may be in oil form, powder form, seed form, leaf form, and the like. The herbs may be dried or fresh. In some aspects, the herbal blend is formed using a combination of oils, powders, seeds, and leaves. In other aspects, the herbal blend is formed using dried herbs, and in one example, the herbs are ground together to form the blend.

In one embodiment, a beverage is a tea beverage (e.g., the beverage comprises a tea). In some embodiments, the beverage is a white tea, yellow tea, green tea, oolong tea, black tea, post-fermented (dark) tea, or herbal tea. Herbal teas include infusions of fruit, leaves, or other parts of the plant, such as steeps of rosehip, chamomile, or rooibos. In another aspect, yerba mate ground leaf is used as a tea. In some embodiments, the beverage composition is a milk tea. In other embodiments, the beverage is a coffee, soda, energy drink, or a juice.

In some embodiments, the beverage composition further comprises one or more additional additives. For example, a beverage composition may comprise supplemental flavors, sweeteners, milk, vitamins, electrolytes, stabilizers, emulsifiers, lecithin, chia seeds, hemp seeds, protein powder, flax seeds, oats, sesame seeds, quinoa, etc.

In some aspects, the beverage composition further comprises supplemental flavors. Tea flavors may be created using herbs or plant matters from spice plants. Tea flavors used in these embodiments may be chosen from a group comprising of orange, citrus, rose, jasmine, berry, osmanthus, chrysanthemum, lotus, mint, pandan, smoke, spices (such as ginger, cardamom, cinnamon, cassia, black pepper, clove, anise, fennel, Indian bay leaf, vanilla, nutmeg, turmeric, or mace), rum, roasted grains and nuts, among other flavors. Flavors may also be added by adding essential oils into loose tea leaf.

In some embodiments, the beverage composition further comprises sweeteners. For example, the sweetener may be derived from sugar, artificial sweetener and natural sweetener. In some embodiments, the beverage composition further comprises milk. The milk may be any form readily available including goat milk, oat milk, cows milk, coconut milk, hemp milk, or a nut milk (e.g., soy, almond, cashew, etc.). In some aspects, the milk is a dry or powdered milk.

The beverage compositions described herein may be provided as ready-to-drink beverages, e.g., the beverage is pre-made and is ready for consumption. In other aspects, the beverage composition is provided in a concentrated form and must be blended with water and/or milk prior to consumption.

The ready-to-drink beverage compositions described herein may be prepared using any hot or cold brew methods known to those of skill in the art. For example, an herbal blend may be steeped in water for a period of time of about 1 minute to 60 minutes, or 5 minutes to 30 minutes. Alternatively, an herbal blend may be steeped in water for a period of time of about 1 hour to 24 hours, or about 6 to about 12 hours. One of skill in the art would adjust the steeping time depending on the temperature of the water and the strength desired from the herbal blend.

In some embodiments, a beverage composition (e.g., a ready-to-drink lactation beverage) is manufactured or made using a blend of herbs (e.g., a blend of 6-9 lactation boosting herbs). In one embodiment, a base blend of herbs includes fennel seed, anise seed, blessed thistle, marshmallow root, lemon grass, lemon verbena, optionally spearmint, and optionally fenugreek. In some embodiments, the herbal blend is formed by combining the selected herbs and grinding the herbs together, e.g., using a spice mill. The herbal blend may be added as a single ingredient to water and steeped, e.g., in one or more tea bags. Optionally, one or more sweeteners (e.g., monk fruit, maple syrup, honey, sugar, stevia) are added to the beverage. In some embodiments, the beverage comprises one or more additional ingredients, such as a supplemental flavor (e.g., lemon juice, alfalfa chlorophyll, hibiscus, a spice mix), milk, emulsifier, and/or stabilizer. In certain embodiments, the supplemental flavor is a galactagogue. In certain embodiments, the supplemental flavor provides additional health benefits to the consumer. In some embodiments, the beverage composition is flavored. In certain embodiments, the beverage composition has a lemon, chai, or hibiscus flavor.

In some embodiments, a hibiscus flavored beverage composition is prepared. The hibiscus flavored beverage may comprise a herbal blend described herein and hibiscus (galactagogue). In some aspects, the beverage further includes spearmint (galactagogue). The herbal blend may be steeped (e.g., in one or more tea bags) in water (e.g., water previously brought to a boil). In some aspects, the herbal blend is steeped for 1 to 20 minutes, 5 to 15 minutes, or 10 to 15 minutes. In some aspects, hibiscus is steeped (e.g., in a tea bag) in water (e.g., water previously brought to boil). In some aspects, the hibiscus is steeped for 5 to 20 minutes or 10 to 15 minutes. In some aspects, spearmint is steeped (e.g., in a tea bag) in water (e.g., water previously brought to a boil). The spearmint may be steeped for 1 to 10 minutes or about 5 minutes. In some aspects, one or more of the herbal blend, hibiscus, and spearmint may be steeped concurrently in the water, alternatively the herbal blend, hibiscus, and spearmint may be steeped in the water consecutively. In some aspects, lemon juice is added to the beverage composition. In some aspects, one or more sweeteners are added. In one embodiment, the sweetener is monk fruit and maple syrup.

In some embodiments, a green chlorophyll beverage composition is prepared. The chlorophyll beverage may comprise a herbal blend described herein. In some aspects, the beverage further includes alfalfa chlorophyll (galactagogue). The herbal blend may be steeped (e.g., in one or more tea bags) in water (e.g., water previously brought to a boil). In some aspects, the herbal blend is steeped for 1 to 20 minutes, 5 to 15 minutes, or 10 to 15 minutes. In some aspects, alfalfa chlorophyll is added to the beverage composition. In some aspects, lemon juice is added to the beverage composition. In some aspects, one or more sweeteners are added. In one embodiment, the sweetener is monk fruit and maple syrup.

In some embodiments, a chai flavored beverage composition is prepared. The chai beverage may comprise a herbal blend described herein and a spice blend comprising one or more of cinnamon, ginger, cardamom, pepper, nutmeg, and cloves. The herbal blend may be steeped (e.g., in one or more tea bags) in water (e.g., water previously brought to a boil). In some aspects, the herbal blend is steeped for 1 to 20 minutes, 5 to 15 minutes, or 10 to 15 minutes. In some aspects, the spice blend is steeped (e.g., in a tea bag) in water (e.g., water previously brought to boil). In some aspects, the spice blend is steeped for 5 to 20 minutes or 10 to 15 minutes. In some aspects, the herbal blend and the spice blend may be steeped concurrently in the water, alternatively the herbal blend and the spice blend may be steeped in the water consecutively. In some aspects, one or more sweeteners are added to the beverage composition. In one embodiment, the sweetener is monk fruit and maple syrup. In some aspects, milk is added to the beverage composition. In one embodiment, the milk is oat milk.

Consumption of the beverage compositions described herein by a nursing mother may result in increased milk production. A nursing mother may include mothers who are nursing from the breast or who are pumping. For example, consumption of a ready-to-drink tea beverage may result in increased milk production of at least 25%, 50%, 75%, 100%, 125%, or 150%, e.g., as measurable by ounces of milk produced per day or per nursing or pumping session. In some aspects, consumption of a ready-to-drink tea beverage results in increased milk production of about 25%-150%, 50%-100%, 60-90%, or 70-80%. The increase in milk production may be a result of how often the tea beverage is consumed by a nursing mother, as well as how long the tea beverage is consumed. For example, consumption of 3-5 glasses of a tea beverage described herein for at least 1 day may result in an increase in milk production, and consumption of 3-5 glasses of tea beverage for at least 7 days may result in a greater increase in milk production. Multiple studies are provided below describing the potential increase in milk production by consuming the tea beverages described herein.

In some embodiments, a nursing mother consumes about 8 to 32 oz, or in certain embodiments about 8 oz, 16 oz, 24 oz, or 32 oz of the beverage composition described herein per day. The nursing mother may consume the beverage composition, e.g., about 8 to 24 oz per day of the beverage composition, for a period of three days, at least 1 week, at least 1 month, at least 3 months, at least 6 months, at least 9 months, at least 12 months, or at least 18 months. In one embodiment, a nursing mother may consume the beverage composition every day that she is nursing or pumping. In alternative embodiments, a nursing mother consumes the beverage composition intermittently over an extended period of time, e.g., 1 to 7 days, 2 to 6 days, or 3 to 5 days per week for at least 1 month, 3 months, 6 months, 9 months, 12 months, or 18 months.

In some embodiments, the beverage compositions are made using one or more organic ingredients. In certain embodiments, a beverage composition comprises only organic ingredients. The organic ingredients may be selected to increase the opportunity for the galactagogues to function together, but to also make the product naturally caffeine-free, dairy-free, gluten-free, vegan and/or kosher. In some aspects, a lactating mother can pass various ingredients or components through her breastmilk, which may affect her infant's digestive system. In some aspects, a tea is formulated for convenient consumption to increase and maintain a milk supply while keeping the nursing mother properly hydrated.

Oxytocin and Prolactin are hormones produced during breastfeeding that work together to make milk, trigger a letdown, and keep up with the supply and demand of a nursing infant. Galactagogues help nursing mothers increase prolactin levels which in turn increases milk production. Oxytocin is not only responsible for the letdown/milk-ejection reflex in mothers, but also an increased thirst. Experts recommend that nursing mothers intake additional fluids to replace the fluids lost to lactation or “drinking to thirst” (approximately 32 oz/4 cups) for about 100 oz per day.

Risk of dehydration for nursing mothers occurs when fluids are not replaced at the rate of which they are being lost. Breastmilk is 90% water and if mothers are not properly hydrated, water is pulled from the mother to meet the demands of the nursing infant. This can result in maternal constipation, general moodiness, impaired concentration, headaches and fatigue.

The beverages described herein address the importance of hydration to a breastfeeding mother, as well as the convenience, control and flexibility that nursing mothers require. Flavors may be selected for improved taste and for the inclusion of additional galactagogues to further increase milk production.

### EXEMPLIFICATION

### Herbal Blend/Base—

### Herbal Blend 1

| | Single Serving | | Ratio | Grams | Ratio |
|---|---|---|---|---|---|
| Fennel Seed | 1 | TSP | 32.47% | 2.5 | 33.56% |
| Anise Seed | 0.5 | TSP | 16.23% | 1.75 | 23.49% |
| Coriander Seed | 0.25 | TSP | 8.12% | 0.75 | 10.07% |
| Blessed Thistle Leaves | 0.125 | TSP | 4.06% | 0.2 | 2.68% |
| Fenugreek Seed | 0.125 | TSP | 4.06% | 0.8 | 10.74% |
| Marshmallow Root | 0.25 | TSP | 8.12% | 0.5 | 6.71% |
| Lemongrass Leaves | 0.25 | TSP | 8.12% | 0.25 | 3.36% |
| Lemon Verbena Leaves | 0.25 | TSP | 8.12% | 0.2 | 2.68% |
| Spearmint Leaves | 0.33 | TSP | 10.71% | 0.5 | 6.71% |
| | 3.08 | | | 7.45 | |
| GROUND | 1 | TSP | | 2.62 | |

### Herbal Blend 2: No Fenugreek

| | Single Serving | | Ratio | Grams | Ratio |
|---|---|---|---|---|---|
| Fennel Seed | 1 | TSP | 33.84% | 2.29 | 38.68% |
| Anise Seed | 0.5 | TSP | 16.92% | 1.85 | 31.25% |
| Coriander Seed | 0.25 | TSP | 8.46% | 0.7 | 11.82% |
| Blessed Thistle Leaves | 0.125 | TSP | 4.23% | 0.2 | 3.38% |
| Fenugreek Seed | 0 | TSP | 0.00% | 0 | 0.00% |
| Marshmallow Root | 0.25 | TSP | 8.46% | 0.28 | 4.73% |
| Lemongrass Leaves | 0.25 | TSP | 8.46% | 0.21 | 3.55% |
| Lemon Verbena Leaves | 0.25 | TSP | 8.46% | 0.18 | 3.04% |
| Spearmint Leaves | 0.33 | TSP | 11.17% | 0.21 | 3.55% |
| | 2.955 | | | 5.92 | |
| GROUND | 1 | TSP | | 2.46 g | |

### Herbal Blend 3: No Spearmint

| | Single Serving | | Ratio | Grams | Ratio |
|---|---|---|---|---|---|
| Fennel Seed | 1 | TSP | 36.36% | 2.29 | 35.39% |
| Anise Seed | 0.5 | TSP | 18.18% | 1.85 | 28.59% |
| Coriander Seed | 0.25 | TSP | 9.09% | 0.7 | 10.82% |
| Blessed Thistle Leaves | 0.125 | TSP | 4.55% | 0.2 | 3.09% |
| Fenugreek Seed | 0.125 | TSP | 4.55% | 0.76 | 11.75% |
| Marshmallow Root | 0.25 | TSP | 9.09% | 0.28 | 4.33% |
| Lemongrass Leaves | 0.25 | TSP | 9.09% | 0.21 | 3.25% |
| Lemon Verbena Leaves | 0.25 | TSP | 9.09% | 0.18 | 2.78% |
| Spearmint Leaves | 0 | TSP | 0.00% | 0 | 0.00% |
| | 2.75 | | | 6.47 | |
| GROUND | 1 | TSP | | 2.46 | |

### Herbal Blend 4: No Fenugreek or Spearmint

| | Single Serving | | Ratio | Grams | Ratio |
|---|---|---|---|---|---|
| Fennel Seed | 1 | TSP | 38.10% | 2.29 | 40.11% |
| Anise Seed | 0.5 | TSP | 19.05% | 1.85 | 32.40% |
| Coriander Seed | 0.25 | TSP | 9.52% | 0.7 | 12.26% |
| Blessed Thistle Leaves | 0.125 | TSP | 4.76% | 0.2 | 3.50% |
| Fenugreek Seed | 0 | TSP | 0.00% | 0 | 0.00% |
| Marshmallow Root | 0.25 | TSP | 9.52% | 0.28 | 4.90% |
| Lemongrass Leaves | 0.25 | TSP | 9.52% | 0.21 | 3.68% |
| Lemon Verbena Leaves | 0.25 | TSP | 9.52% | 0.18 | 3.15% |
| Spearmint Leaves | 0 | TSP | 0.00% | 0 | 0.00% |
| | 2.625 | | | 5.71 | |
| GROUND | 1 | TSP | | 2.46 g | |

The herbal blend may be prepared by combining the fennel, anise, blessed thistle, marshmallow root, lemon grass, lemon verbena, coriander, and optionally spearmint and/or fenugreek, and grinding the herbs together, e.g., using a spice mill or other device.

### Beverage 1—Hibiscus Tea

A ready-to-drink beverage comprises an herbal blend comprising fennel seed, anise seed, fenugreek, coriander, blessed thistle, marshmallow root, lemon grass, lemon verbena, and spearmint. The beverage further includes hibiscus, water, lemon juice, spearmint, maple syrup and monk fruit.

The beverage is prepared by bringing 64 oz water to boil and then removing the water from the heat. The herbal blend is steeped in the hot water for 10 to 15 minutes. In addition, a tea bag of hibiscus and a tea bag of spearmint are steeped with the herbal blend. The bag of spearmint is allowed to steep for 5 minutes, while the bag of hibiscus is allowed to steep for 10-15 minutes. While the steeping process occurs a bottle is prepared by adding lemon juice, monk fruit, and maple syrup to the bottle. After the steeping process is completed the liquid is strained and is added to the bottle. The bottle is shaken to distribute the ingredients and is then refrigerated. Generally a 64 oz batch of the beverage is prepared.

The ingredient distribution for an 8 oz serving is as follows:

| | Single Serving | | Ratio | Grams | Ratio |
|---|---|---|---|---|---|
| Herbal Blend | 1 | TSP | 1.84% | 2.62 | 0.93% |
| Hibiscus | 3 | TSP | 5.53% | 4.73 | 1.68% |
| Spearmint | 0.5 | TSP | 0.92% | 0.22 | 0.08% |
| Lemon Juice | 0.5 | TSP | 0.92% | 2.4 | 0.85% |
| Monk fruit | 0.25 | TSP | 0.46% | 1.3 | 0.46% |
| Maple Syrup | 1 | TSP | 1.84% | 6.9 | 2.45% |
| Water (8oz) | 48 | TSP | 88.48% | 264 | 93.56% |
| | 54.25 | | | 282.17 | |

### Beverage 2—Lemon Flavored Green Chlorophyll Tea

A ready-to-drink beverage comprises an herbal blend comprising fennel seed, anise seed, fenugreek, coriander, blessed thistle, marshmallow root, lemon grass, lemon verbena, and spearmint. The beverage further includes water, lemon juice, alfalfa chlorophyll, maple syrup, and monk fruit.

The beverage is prepared by bringing 64 oz water to boil and then removing the water from the heat. The herbal blend is steeped in the hot water for 10 to 15 minutes. While the steeping process occurs a bottle is prepared by adding lemon juice, alfalfa chlorophyll, monk fruit, and maple syrup to the bottle. After the steeping process is completed the liquid is strained and is added to the bottle. The bottle is shaken to distribute the ingredients and is then refrigerated. Generally a 64 oz batch of the beverage is prepared.

The ingredient distribution for an 8 oz serving is as follows:

| | Single Serving | | Ratio | Grams | Ratio |
|---|---|---|---|---|---|
| Herbal Blend | 1 | TSP | 1.91% | 2.46 | 0.87% |
| Liquid Chlorophyll | 0.5 | TSP | 0.96% | 2.86 | 1.01% |
| Lemon Juice | 1.75 | TSP | 3.35% | 9.86 | 3.49% |
| Monk fruit | 0.25 | TSP | 0.48% | 1.34 | 0.47% |
| Maple Syrup | 0.75 | TSP | 1.44% | 6.18 | 2.19% |
| Water (8oz) | 48 | TSP | 91.87% | 260 | 91.97% |
| | 52.25 | | | 282.7 | |

### Beverage 3—Chai

A ready-to-drink beverage comprises an herbal blend comprising fennel seed, anise seed, fenugreek, coriander, blessed thistle, marshmallow root, lemon grass, lemon verbena, and spearmint. The beverage further includes water, a spice blend of cinnamon, ginger, cardamom, pepper, nutmeg, and cloves, maple syrup, monk fruit, and oat milk.

The spice blend is as follows:

| | Batched Servings (~32) | | Ratio |
|---|---|---|---|
| Cinnamon | 12 | TSP | 44.04% |
| Ginger | 9 | TSP | 33.03% |
| Cardamom | 4.5 | TSP | 16.51% |
| Black Pepper | 0.25 | TSP | 0.92% |
| Nutmeg | 0.75 | TSP | 2.75% |
| Cloves | 0.75 | TSP | 2.75% |
| | 27.25 | | |

In other examples the spice blend is as follows:

| | Batched Servings (~32) | | Ratio |
|---|---|---|---|
| Cinnamon | 12 | TSP | 44.24% |
| Ginger | 9 | TSP | 33.18% |
| Cardamom | 4.5 | TSP | 16.59% |
| Black Pepper | 0.125 | TSP | 0.46% |
| Nutmeg | 0.75 | TSP | 2.76% |
| Cloves | 0.75 | TSP | 2.76% |
| | 27.125 | | |

The beverage is prepared by bringing 32 oz water to boil and then removing the water from the heat. The herbal and spice blends are steeped in the hot water for 10 to 15 minutes. While the steeping process occurs the bottle is prepared by adding monk fruit and maple syrup to the bottle. After the steeping process is completed the liquid is strained and is added to the bottle. The bottle is shaken to distribute the ingredients and 32 oz oat milk is then added. The bottle is shaken again and is then refrigerated. Generally, a 64 oz batch of the beverage is prepared.

The ingredient distribution for an 8 oz serving is as follows:

| | Single Serving | | Ratio | Grams | Ratio |
|---|---|---|---|---|---|
| Herbal Blend | 1 | TSP | 1.96% | 2.62 | 1.00% |
| Chai Spices | 0.75 | TSP | 1.47% | 1.67 | 0.64% |
| Monk fruit | 0.25 | TSP | 0.49% | 1.3 | 0.50% |
| Maple Syrup | 1 | TSP | 1.96% | 6.9 | 2.64% |
| Water (4oz) | 24 | TSP | 47.06% | 132 | 50.48% |
| Oat Milk (4oz) | 24 | TSP | 47.06% | 117 | 44.74% |
| | 51 | | | 261.49 | |

### Increased Lactation

### Study 1:

A nursing mother was producing about 28 oz milk per day on her own (with no supplements). She then consumed about 24 oz per day of a ready-to-drink beverage described herein for three days and saw her milk production steadily increase over those three days to 47.5 oz per day. The increase was as follows: Day 1=36 oz, Day 2=42 oz, Day 3=47.5 oz.

### Study 2:

A nursing mother of twins was consistently producing 9 oz milk in her 6:30 morning pump (post breastfeed) on her own (with no supplements). She consumed 8 oz. of a ready-to-drink beverage described herein once per day at 6 pm for three days and saw her 6:30 am pump (post breastfeed) the following morning increased from 9 oz. to between 14 and 16 oz. The increase was as follows: Day 1=14 oz, Day 2=14oz, Day 3=16 oz

### Study 3:

A nursing mother was producing about 28 oz milk per day on her own (with no supplements). Over a 14-day period she consumed on average 27 oz. daily of a ready-to-drink beverage described herein and was able to increase and maintain her milk production at an average of 46 oz. per day.

### Study 4:

A nursing mother was producing about 14-20 oz milk per day on her own (with no supplements), but required an additional 16-24 oz of formula per day to meet her baby's required daily needs. Over a 3-day period she consumed on average 28 oz. daily of a ready-to-drink beverage described herein and by day 4, was able to increase her milk production to an average of 40 oz a day, thereby eliminating the need to supplement breast milk with formula. She continued to drink about 28 oz daily to exclusively breastfeed her baby for an additional 3 months.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or prior publication, or for any other reason. All statements as to the date or representation as to the contents of these documents is based on the information available to the applicants and does not constitute any admission as to the correctness of the dates or contents of these documents.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where the claims or description relate to a composition of matter, it is to be understood that methods of making or using the composition of matter according to any of the methods disclosed herein, and methods of using the composition of matter for any of the purposes disclosed herein are aspects of the invention, unless otherwise indicated or unless it would be evident to one of ordinary skill in the art that a contradiction or inconsistency would arise. Where the claims or description relate to a method, e.g., it is to be understood that methods of making compositions useful for performing the method, and products produced according to the method, are aspects of the invention, unless otherwise indicated or unless it would be evident to one of ordinary skill in the art that a contradiction or inconsistency would arise.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited.

1. A beverage composition comprising:
an herbal blend of fennel, anise, coriander, lemon grass, lemon verbena, marshmallow root, and blessed thistle; and
a sweetener.

2. The beverage composition of claim 1, wherein the herbal blend comprises about 39-41 wt % fennel seed, about 31-33 wt % anise seed, about 11-13 wt % coriander seed, about 2-4 wt % blessed thistle leaves, about 3-5 wt % marshmallow root, about 2-4 wt % lemongrass leaves, and about 2-4 wt % lemon verbena leaves.

3. (canceled)

4. The beverage composition of claim 1, wherein the herbal blend further comprises fenugreek.

5. The beverage composition of claim 4, wherein the herbal blend comprises about 34-36 wt % fennel seed, about 27-29 wt % anise seed, about 9-11 wt % coriander seed, about 2-4 wt % blessed thistle leaves, about 10-12 wt % fenugreek seed, about 3-5 wt % marshmallow root, about 2-4 wt % lemongrass leaves, and about 1-3 wt % lemon verbena leaves.

6. (canceled)

7. The beverage composition claim 1, wherein the herbal blend further comprises spearmint.

8. The beverage composition of claim 7, wherein the herbal blend comprises about 37-39 wt % fennel seed, about 30-32 wt % anise seed, about 10-12 wt % coriander seed, about 2-4 wt % blessed thistle leaves, about 3-5 wt % marshmallow root, about 2-4 wt % lemongrass leaves, about 2-4 wt % lemon verbena leaves, and about 2-4 wt % spearmint leaves.

9. (canceled)

10. The beverage composition of claim 1, wherein the herbal blend further comprises spearmint and fenugreek.

11. The beverage composition of claim 10, wherein the herbal blend comprises about 33-35 wt % fennel seed, about 26-28 wt % anise seed, about 9-11 wt % coriander seed, about 1-3 wt % blessed thistle leaves, about 10-12 wt % fenugreek seed, about 3-5 wt % marshmallow root, about 2-4 wt % lemongrass leaves, about 1-3 wt % lemon verbena leaves, and about 2-4 wt % spearmint leaves.

12. (canceled)

13. The beverage composition of claim 1, wherein the herbal blend does not comprise fenugreek and/or spearmint.

14. (canceled)

15. The beverage composition of claim 1, wherein the beverage composition is a ready-to-drink beverage composition.

16. (canceled)

17. The beverage composition of claim 1, wherein the sweetener is selected from the group consisting of monk fruit, maple syrup, honey, sugar, stevia, and combinations thereof.

18. (canceled)

19. The beverage composition of claim 1, further comprising lemon juice, hibiscus, and/or spearmint leaves.

20. (canceled)

21. (canceled)

22. The beverage composition of claim 1, further comprising alfalfa chlorophyll and/or lemon juice.

23. The beverage composition of claim 1, further comprising a spice blend comprising one or more of cinnamon, ginger, cardamom, black pepper, nutmeg, and cloves.

24. (canceled)

25. The beverage composition of claim 23, further comprising milk.

26. (canceled)

27. The beverage composition of claim 1, wherein the beverage consumption is prepared using a hot or cold brew production process.

28. The beverage composition of claim 1, wherein consumption of the beverage composition by a nursing mother results in increased lactation.

29. (canceled)

30. (canceled)

31. A method of increasing lactation in a nursing mother comprising the nursing mother consuming the beverage composition of claim 1.

32. (canceled)

33. The method of claim 31, wherein the nursing mother consumes about 24 oz of the beverage composition for a period of at least three days.

34. The method of claim 31, wherein lactation is increased by about 25%.

35. (canceled)
